(19) United States
(12) Patent Application Publication
(10) Pub. No.: US 2025/0347783 A1
(43) Pub. Date: Nov. 13, 2025

(54) METHOD AND APPARATUS FOR MONITORING LIDAR READOUT CIRCUIT AND LIDAR

(71) Applicant: HESAI TECHNOLOGY CO., LTD., Shanghai (CN)

(72) Inventors: Chengguang LI, Shanghai (CN); Fei GAO, Shanghai (CN); Biao WANG, Shanghai (CN); Shaoqing XIANG, Shanghai (CN)

(73) Assignee: HESAI TECHNOLOGY CO., LTD., Shanghai (CN)

(21) Appl. No.: 19/220,693

(22) Filed: May 28, 2025

Related U.S. Application Data
(63) Continuation of application No. PCT/CN2023/135168, filed on Nov. 29, 2023.

(30) Foreign Application Priority Data
Nov. 29, 2022 (CN) 202211509792.6

(51) Int. Cl. G01S 7/4861; G01S 7/497; G01S 17/89

(52) U.S. Cl. CPC G01S 7/4861; G01S 7/497; G01S 17/89

(57) ABSTRACT

Methods for monitoring a readout circuit of a LiDAR includes: initiating a diagnosis of the readout circuit; outputting a diagnosis signal to the readout circuit, and outputting, by the readout circuit, diagnosis data based on the diagnosis signal, where the diagnosis signal is generated by switching a photoelectric detector from an activated state to an inactivated state; and determining whether a fault exists in the readout circuit by comparing the diagnosis data with reference data, where the reference data is readout data outputted based on the diagnosis signal when the readout circuit functions normally.

### CROSS-REFERENCE TO RELATED APPLICATION(S)

This application claims priority to Chinese Patent Application No. 202211509792.6, filed on Nov. 29, 2022, the content of which is incorporated herein by reference in its entirety.

### TECHNICAL FIELD

This disclosure relates to technical field of circuit monitoring technology, in particular to methods and apparatuses for monitoring a readout circuit of a LiDAR, and LiDARs.

### BACKGROUND

A LiDAR is a sensor that performs active detection. The LiDAR can transmit a detection signal to a scene. The detection signal can be reflected off (e.g., by diffuse reflection) a surface of an object in the scene to generate an echo signal. The echo signal can be received by the LiDAR. The LiDAR compares the received echo signal with the transmitted signal to obtain information of the object (e.g., a position, or a motion state of the object) for detecting, tracking, positioning, and identifying the object. The LiDAR can include a laser transmitter and a receiver. The receiver is one of core components in LiDAR, and it can include a photoelectric detector and a readout circuit. The data receiving process of the receiver can include: the photoelectric detector receives a light signal and converts the light signal into an electric signal, and the readout circuit processes the electric signal to obtain information, such as time of flight, reflectivity, or the like.

The readout circuit can include a plurality of elements. Once some elements operates abnormally, an error in the readout data of a line or a plurality of lines in the point cloud occur (e.g., the result of ranging is higher or lower than the true value). If the abnormality of the readout circuit fails to be found in time, measurement is performed based on the wrong ranging data, which can cause safety accidents. A diagnosis method for detecting the readout circuit includes: a light emitter emits a reference light signal to the photoelectric detector, the photoelectric detector outputs an electrical signal in response to the reference light signal, and the photoelectric detector determines whether the readout circuit is abnormal by determining the readout data output from the readout circuit trigger by the electric signal. Theoretically, the electrical signal output by the photoelectric detector when receiving the same reference light signal should be of a fixed value, but in fact, the photoelectric detector do not only receive the reference light signal, but also receive an ambient light signal. As it is difficult to keep the ambient light signal consistent, this diagnosis method is greatly affected by the ambient light. Even if the strengths of reference light signals are consistent during respective monitoring, under different ambient light conditions, the consistency of the light signal incident on the photoelectric detector cannot be ensured. Therefore, it is difficult to make determination accurately by using this diagnosis method for detecting abnormality of the readout circuit based on reference light signal.

### SUMMARY

This disclosure provides a method and an apparatus for monitoring a readout circuit of the LiDAR and a LiDAR to monitor the readout circuit in an easy, convenient and accurate way.

In one aspect, this disclosure provides a method for monitoring a readout circuit of a LiDAR, including: initiating a diagnosis of the readout circuit; outputting a diagnosis signal to the readout circuit, and outputting, by the readout circuit, diagnosis data based on the diagnosis signal, wherein the diagnosis signal is generated by switching a photoelectric detector from an activated state to an inactivated state; and determining whether a fault exists in the readout circuit by comparing the diagnosis data with reference data, wherein the reference data is readout data outputted based on the diagnosis signal when the readout circuit functions normally.

Optionally, the LiDAR includes one or more readout circuits. The initiating the diagnosis of the readout circuit includes initiating diagnoses of the one or more readout circuits in parallel.

Optionally, the LiDAR includes one or more readout circuits. The initiating the diagnosis of the readout circuit includes: initiating diagnoses of the one or more readout circuits separately.

Optionally, each of one or more readout circuits is connected to one or more photoelectric detectors. The diagnosis signal is generated by switching the photoelectric detectors connected to a same readout circuit from the activated state to the inactivated state.

Optionally, the reference data corresponds to a number of photoelectric detectors connected to the same readout circuit and switched from the activated state to the inactivated state.

Optionally, the determining whether the fault exists in the readout circuit by comparing the diagnosis data with the reference data includes: based on a determination that a deviation between the diagnosis data and the reference data is beyond a predetermined range, determining that the fault exists in the readout circuit.

Optionally, the determining whether the fault exists in the readout circuit by comparing the diagnosis data with the reference data includes: based on a determination that the deviation between the diagnosis data and the reference data is within the predetermined range, determining that the fault does not exist in the readout circuit.

Optionally, the method further includes: making a fault response after determining that the fault exists in the readout circuit.

Optionally, the predetermined range comprises a plurality of predetermined ranges. The method further includes: determining a fault level of the readout circuit based on correspondence between the deviation and the plurality of predetermined ranges, and making different fault responses based on the fault level.

In a second aspect, this disclosure provides an apparatus, the apparatus can be configured to monitor the readout circuit. The apparatus including: a safety management unit, a controller, and a detector control circuit. The detector control circuit includes a photoelectric detector. The safety management unit is configured to send a command for readout circuit diagnosis to the controller. The controller is configured to output a control signal to the detector control circuit after receiving the command, the control signal is for switching the photoelectric detector from an activated state to an inactivated state. The detector control circuit is configured to switch the photoelectric detector from the activated state to the inactivated state based on the control signal, and output a diagnosis signal to the readout circuit. The readout circuit is configured to output diagnosis data to the safety management unit based on the diagnosis signal. The safety management unit is further configured to receive the diagnosis data, and determine whether a fault exists in the readout circuit by comparing the diagnosis data with reference data, wherein the reference data is readout data output based on the diagnosis signal when the readout circuit functions normally.

Optionally, the apparatus simultaneously monitors one or more readout circuits. Optionally, each of the readout circuits is connected to one or more detector control circuits; the controller, after receiving the command, outputs the control signal to the detector control circuits connected to the same readout circuit, and the detector control circuits generate the diagnosis signals based on the control signal, and outputs the diagnosis signals to the readout circuit.

Optionally, the detector control circuit includes a control switch, a first signal generation unit and/or a second signal generation unit; the control switch is configured to switch the photoelectric detector from the activated state to the inactivated state based on the control signal; the first signal generation unit is configured to output a first diagnosis signal to the readout circuit after the control switch switches the photoelectric detector from the activated state to the inactivated state; the second signal generation unit is configured to output a second diagnosis signal to the readout circuit after the control switch switches the photoelectric detector from the activated state to the inactivated state.

Optionally, the control switch includes a first switch and a second switch.

Optionally, two terminals of the first switch are connected to a power source and the photoelectric detector respectively, two terminals of the second switch are connected to the photoelectric detector and ground respectively, and the control terminals of the first switch and the second switch are connected to an output terminal of the controller; after the controller outputs the control signal, the first switch is turned off and the second switch is turned on.

Optionally, the first switch is a PMOS transistor or an NMOS transistor.

Optionally, the first signal generation unit is a capacitor, one terminal of the capacitor is connected to the photoelectric detector, and the other terminal is used as a first output terminal of the detector control circuit.

Optionally, the second signal generation unit is an inverter; an input terminal of the inverter is connected to the photoelectric detector, and an output terminal of the inverter is used as a second output terminal of the detector control circuit.

Optionally, the apparatus includes a plurality of detector control circuits, and all of the plurality of detector control circuits are connected to the readout circuit.

Optionally, the command carries a detector channel identifier; the controller outputs the control signal to a corresponding detector control circuit based on the detector channel identifier.

Optionally, the safety management unit is further configured to make a fault response when it is determined that the fault exists in the readout circuit.

Optionally, the safety management unit is further configured to determine a fault level of the readout circuit and making a fault response based on the fault level.

Optionally, the safety management unit is further configured to send a fault code to a main controller via a communication interface.

Optionally, the safety management unit is configured to send the fault code to the main controller after determining the fault level of the readout circuit as a first level; and the safety management unit is configured to send the fault code to the main controller and stops sending point cloud data to the main controller, after determining the fault level of the readout circuit as a second level.

Optionally, the fault code includes readout circuit fault indication information and identification information indicating a faulty readout circuit.

Optionally, the safety management unit is configured to send a fault signal to the main controller via an interrupt pin, after determining that the fault exists in the readout circuit. The main controller is configured to read data stored in the safety management unit via a communication interface after receiving the fault signal, and determines fault information of the readout circuit based on the read data.

Optionally, the fault signal sent to the main controller via the interrupt pin is used to indicate a fault in the readout circuit and/or the fault level.

In a third aspect, this disclosure provides a LiDAR, including a transmitting end and a receiving end. The transmitting end is configured to transmit a detection signal towards a target object. The receiving end is configured to receive an echo signal generated after the detection signal is reflected by the target object. The receiving end includes the apparatus for monitoring a readout circuit of a LiDAR set forth above.

In a fourth aspect, this disclosure provides a terminal device, including the LiDAR provided in third aspect, and a connector configured to connect the LiDAR and the terminal device.

Optionally, the terminal device includes a vehicle, a drone or a robot.

Based on the methods and the apparatuses for monitoring a readout circuit of the LiDAR and a LiDAR provided in this disclosure, after initiating the diagnosis of the readout circuit, the diagnostic signal can be output to the readout circuit, and the readout circuit can output the diagnostic data based on the diagnostic signal; the diagnostic signal can be generated by switching the photoelectric detector from an activated state to an inactivated state; and determining whether the fault exists in the readout circuit by comparing the diagnostic data with the reference data. Because the diagnostic signal output to the readout circuit can be not obtained by the response of the photoelectric detector to the light signal, it can be not affected by the external ambient light, and it is possible to determine whether the fault exists in the readout circuit accurately based on the diagnostic data, so that the readout circuit can be monitored in a simple, convenient and accurate way. There is no need to send a light signal to the detector during diagnosis, so that the monitoring method can be simple and easy to implement. The diagnosis of the readout circuit can be carried out at any time during the normal operation of the LiDAR, and the diagnosis process of the readout circuit does not affect the normal detection process of the LiDAR.

In addition, the diagnostic signal is generated by switching the photoelectric detector from the activated state to the inactivated state. When diagnosing the readout circuit, the corresponding photoelectric detector is in the inactivated state. Therefore, the technical solution may perform detection during the interval when the photoelectric detector is not operating, without affecting the normal operation of the photoelectric detector.

Further, after determining that the fault exists in the readout circuit, a fault response is made, and the fault can be handled in time and the normal operation of the readout circuit can be better ensured.

### BRIEF DESCRIPTION OF THE DRAWINGS

The drawings are used to provide further understanding to this disclosure, which form part of the specification. The drawings are used in conjunction with some embodiments of this disclosure to explain this disclosure, which do not constitute limitation to this disclosure.

FIG. 1 shows a flowchart illustrating an example method for monitoring a readout circuit of the LiDAR, consistent with some embodiments of this disclosure.

FIG. 2 shows a schematic diagram illustrating an example structure of an apparatus for monitoring the readout circuit of the LiDAR, consistent with some embodiments of this disclosure.

FIG. 3 shows a schematic diagram illustrating an example structure of a detector control circuit in the apparatus for monitoring the readout circuit of the LiDAR, consistent with some embodiments of this disclosure.

FIG. 4 shows a schematic diagram illustrating an example structure of an apparatus for monitoring the readout circuit of the LiDAR, consistent with some embodiments of this disclosure.

FIG. 5 shows a schematic diagram illustrating another example structure of an apparatus for monitoring the readout circuit of the LiDAR, consistent with some embodiments of this disclosure.

FIG. 6 illustrates an example of a first switch in the apparatus for monitoring the readout circuit of the LiDAR shown in FIG. 4.

FIG. 7 illustrates an example of a first switch in the apparatus for monitoring the readout circuit of the LiDAR shown in FIG. 5.

FIG. 8 shows a schematic diagram illustrating an example structure of the readout circuit, consistent with some embodiments of this disclosure.

FIG. 9 shows a schematic diagram illustrating an example apparatus for monitoring the readout circuit of the LiDAR having a plurality of detector control circuits provided, consistent with some embodiments of this disclosure.

FIG. 10 shows a schematic diagram illustrating an example two-dimension structure of a two-dimension detector control circuit corresponding to a two-dimension photoelectric sensor array, consistent with some embodiments of this disclosure.

FIG. 11 shows a schematic diagram illustrating an example control principle of a two-dimension detector control circuit, consistent with some embodiments of this disclosure.

FIG. 12 shows a schematic diagram illustrating an example principal of a fault response made by a safety management unit in an apparatus for monitoring the readout circuit of the LiDAR, consistent with some embodiments of this disclosure.

### DETAILED DESCRIPTION

This disclosure are described in detail below in conjunction with the drawings.

This disclosure provides methods and apparatuses for monitoring a readout circuit of a LiDAR. For example, when detecting the readout circuit, a diagnostic signal is generated by a circuit, and the diagnostic signal is outputted to the readout, instead of emitting a reference light signal to the photoelectric detector. The readout circuit can output diagnostic data based on this diagnostic signal, and whether a fault exists in the readout circuit can be determined by comparing the diagnostic data with a reference data. The diagnostic signal output to the readout circuit cannot be affected by external ambient light, whether the fault exists in the readout circuit can be more accurately determined based on this diagnostic data, thereby the readout circuit is monitored in a simple, convenient, and accurate way.

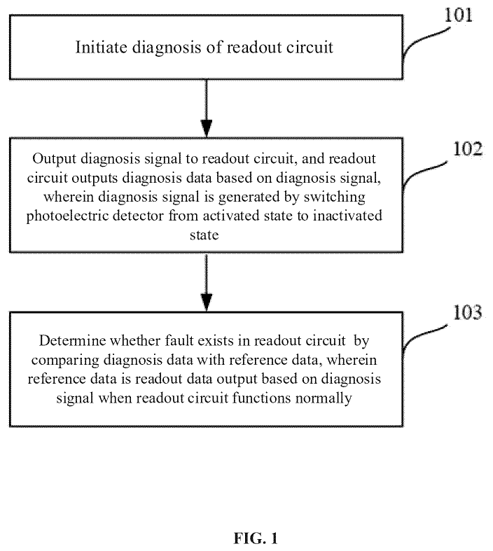

FIG. 1 shows a flowchart illustrating an example method for monitoring a readout circuit of the LiDAR, consistent with some embodiments of this disclosure. As shown in FIG. 1, the example method 100 includes the following steps.

At step 101, a diagnosis of the readout circuit is initiated.

In some embodiments, the diagnosis of the readout circuit can be initiated during an interval when the photoelectric detector of the LiDAR is not operating, for example, when the photoelectric detector does not need to detect echo signal. The diagnosis of the readout circuit can be initiated by a controller, a processor, or the like. For example, the controller can send a initiating signal to control an apparatus to initiate a diagnosis of the readout circuit. The apparatus can initiate the diagnosis of the readout circuit, based on the initiating signal. The apparatus can include the readout circuit. In some embodiments, the apparatus and the readout circuit can connect or communicate to each other by wire or wireless ways. For example, a processor in LiDAR can initiate a diagnosis of the readout circuit when the processor determine the photoelectric detector does not need to detect echo signal for a time period.

At step 102, a diagnostic signal is outputted to the readout circuit. The readout circuit outputs diagnostic data based on the diagnostic signal. The diagnostic signal is generated by switching the photoelectric detector from an activated state to an inactivated state.

The photoelectric detector can generate an electric signal in response to a light signal in the activated state, but do not respond to a light signal in the inactivated state. Correspondingly, there can be no electric signal output to the readout circuit when the photoelectric detector in the inactivated state. The activated state and inactivated state of the photoelectric detector can be changed by controlling a bias voltage of the photoelectric detector, or by controlling the photoelectric detector to be connected to or disconnected from the readout circuit. The diagnostic signal can be generated by switching the photoelectric detector from the activated state to the inactivated state. For example, the diagnostic signal can be generated in a connection circuit between the photoelectric detector and the readout circuit by switching the photoelectric detector from the activated state to the inactivated state. The diagnostic signal can be a known and fixed pulse signal. The diagnostic signal can be output to the readout circuit directly, or through one or more components or devices, such as a resistor, a logic gate, or the like.

At step 103, whether a fault exists in the readout circuit is determined by comparing the diagnostic data with reference data. The reference data is the readout data output based on the diagnostic signal when the readout circuit functions normally.

In some embodiments, whether the fault exists in the readout circuit can be determined by a controller, a processor, a safety management unit, a signal processor circuit or the like. For example, the processor can receive the diagnostic data and reference data. The processor can compare the diagnostic data with the reference data to determine whether the fault exists in the readout circuit.

For a known and fixed pulse signal, when the readout circuit functions normally, the readout data outputted by the readout circuit can fall within a predetermined range, such as the reference data. The reference data can be data with a certain value or values within a certain range. For example, the reference data can be set and stored in a safety management unit or a memory before the LiDAR leaves a factory, and the reference data can be used in subsequent diagnosis process. For example, the reference data can be obtained during the use of LiDAR. When it is diagnosed that the fault does not exist in the readout circuit, the reference data can be obtained by real-time measurement or measurements at a certain interval. For example, the diagnostic data obtained at this time is stored. In the case the diagnosis is completed and the readout circuit operates normally is determined, the diagnostic data can be used as reference data in subsequent diagnoses. Whether the fault exists in the readout circuit can be determined by evaluating the diagnostic data output by the readout circuit based on the reference data. For example, based on a determination that the deviation between the diagnostic data and the reference data is beyond a predetermined range, it is determined that there are a fault in the readout circuit. If the deviation between the diagnostic data and the reference data is within the predetermined range, it is determined that there is the fault does not exist in the readout circuit.

The LiDAR can include one or more readout circuits. Accordingly, the diagnosis of the one or more readout circuits can be initiated in parallel, or separately.

In addition, each of the readout circuits can be connected to one or more photoelectric detectors. For example, when diagnosing the readout circuit, all photoelectric detectors can be disconnected from the readout circuit. For example, when diagnosing the readout circuit, all photoelectric detectors connected to the readout circuit can be switched from the activated state to the inactivated state. For example, when diagnosing the readout circuit, some of the photoelectric detectors can be disconnected from the readout circuit and the other photoelectric detectors can be switched from the activated state to the inactivated state, which is not limited in this disclosure.

In some embodiments, the photoelectric detectors can be connected or disconnected or caused to change the state (e.g., switch from the activated state to the inactivated state) by a controller, a switch or a switch circuit, a safety management unit, or the like. For example, the controller can control a switch to disconnect a photoelectric detector from the readout circuits. As another example, the controller can control a switch to disconnect more than one photoelectric detectors from the readout circuits.

For example, each readout circuit can be connected to one photoelectric detector. When diagnosing the readout circuit, the photoelectric detector can be switched from the activated state to the inactivated state, a diagnostic signal can be generated, and the diagnostic signal is outputted to the readout circuit. The readout circuit outputs diagnostic data based on the diagnostic signal, and whether a fault exists in the readout circuit can be determined based on this diagnostic data.

For another example, each of the readout circuits can be connected to a plurality of photoelectric detectors. When diagnosing the readout circuit, the photoelectric detectors connected to the readout circuit are switched from the activated state to the inactivated state and a diagnostic signal is generated, the diagnostic signal is outputted to the readout circuit. The readout circuit outputs diagnostic data based on the diagnostic signal, and whether a fault exists in the readout circuit can be determined based on this diagnostic data.

In a case a plurality of photoelectric detectors are connected to a single readout circuit, the reference data corresponds to the number of photoelectric detectors connected to the readout circuit and switched from the activated state to the inactivated state. For example, the output electric signals of a plurality of photoelectric detectors connected to the same readout circuit are superimposed by the readout circuit, and the superimposed signal is relevant to the number of photoelectric detectors. Correspondingly, the diagnostic data output by the one readout circuit is relevant to the number of photoelectric detectors that are connected to the diagnostic circuit and have been state-switched (e.g., from the activated state to the inactivated state).

In some embodiments, a fault response can be made after determining that the fault exists in the readout circuit.

In some embodiments, the fault can be classified into different levels. The fault level of the readout circuit can be further determined, in a case the fault exists in the readout circuit is determined, and the fault response can be made based on the fault level. The classification of the fault levels and the corresponding method for fault response can be determined as needed, which are not limited in this disclosure.

For example, a plurality of the predetermined ranges can be set, and the fault level of the readout circuit can be determined based on correspondence between the deviation and the plurality of the predetermined ranges. Different fault responses can be made based on this fault level.

In some embodiments, after initiating a diagnosis of the readout circuit, the photoelectric detector can be switched from the activated state to the inactivated state, a diagnostic signal can be generated, and the diagnostic signal can be directly outputted to the readout circuit with less interference. The diagnosis signal inputted to the readout circuit is not affected by other factors. At that time the photoelectric detector is in an inactivated state (e.g., the photoelectric detector does not sense light signals input from exterior environment), the diagnostic signal inputted to the readout circuit can remain consistent and determinate without being affected by ambient light. The readout circuit can output determinate diagnostic data based on the diagnostic signal, improving the accuracy of the determination whether the fault exists in the readout circuit based on the diagnostic data output by the readout circuit, allowing for monitoring of the readout circuit in a simple, convenient, and accurate way. A fault response can be made after determining that the fault exists in the readout circuit, allowing for timely handling the fault, better ensuring normal operation of the readout circuit or improving the normal operation time and experience of the readout circuit.

FIG. 2 shows a schematic diagram illustrating an example structure of an apparatus for monitoring the readout circuit of the LiDAR, consistent with some embodiments of this disclosure.

The apparatus for monitoring the readout circuit of the LiDAR includes a safety management unit 21, a controller 22, and a detector control circuit 23. The detector control circuit 23 includes a photoelectric detector 230.

The safety management unit 21 can send a command for readout circuit diagnostic (or a “readout circuit diagnostic command”) to the controller 22.

The controller 22 can output a control signal to the detector control circuit 23 upon receiving the readout circuit diagnostic command. The control signal can be used to switch the photoelectric detector from an activated state to an inactivated state.

The detector control circuit 23 can switch the photoelectric detector 230 from the activated state to the inactivated state based on the control signal. And, the detector control circuit 23 generates a diagnostic signal and outputs the diagnostic signal to the readout circuit 20.

The readout circuit 20 can output diagnostic data to the safety management unit 21 based on the diagnostic signal.

The safety management unit 21 can receive the diagnostic data and compare the diagnostic data with reference data to determine whether the fault exists in the readout circuit. The reference data can be the readout data output by the readout circuit when the readout circuit functions normally.

In some embodiments, the diagnostic signal can be generated by switching the photoelectric detector 230 from the activated state to the inactivated state. The photoelectric detector 230 does not perform normal detection when it is in the inactivated state. The safety management unit 21 can send a readout circuit diagnostic command to the controller 22 at an interval when the photoelectric detector 230 is not operating. The normal operation of the readout circuit 20 is not affected.

The diagnostic signal can be a known and fixed pulse signal, the amplitude of the diagnostic signal is related to the characteristics of the circuit. If respective components of the detector control circuit 23 are determinate, the pulse signal can remain consistent and known.

For a known pulse signal, when the readout circuit 20 functions normally, readout data should be within a predetermined range. By determining the diagnostic data, whether the fault exists in the readout circuit can be determined, for example, by comparing the diagnostic data with the reference data, wherein the reference data is readout data output by the readout circuit based on the diagnostic signal when the readout circuit functions normally.

If a deviation between the diagnostic data and the reference data is beyond the predetermined range, it is determined that the fault exists in the readout circuit 20. Or if the deviation between the diagnostic data and the reference data is within the predetermined range, it is determined that the readout circuit 20 operates normally.

Because the pulse signal input to the readout circuit 20 (e.g., the diagnostic signal) can be generated completely by the detector control circuit 23, and because the photoelectric detector 230 can be in the inactivated state and do not sense the external light signals at that time, the pulse signal inputted to the readout circuit 20 can remain consistent and determinate without being affected by ambient light. The readout circuit 20 can output the determinate data, such as the diagnostic data, based on the known pulse signal. Based on the diagnostic data, whether the readout circuit 20 operates normally or the fault exists in the readout circuit 20 can be accurately determined.

In some embodiments, the detector control circuit 23 and the controller 22 in the apparatus for monitoring the readout circuit of the LiDAR shown in FIG. 2 can be some modules already provided in the receiving system of the LiDAR. For example, the apparatus for monitoring the readout circuit of the LiDAR can reuse some existing devices in the LiDAR, without providing additional circuits, thereby facilitating the implementation of the apparatus of this disclosure.

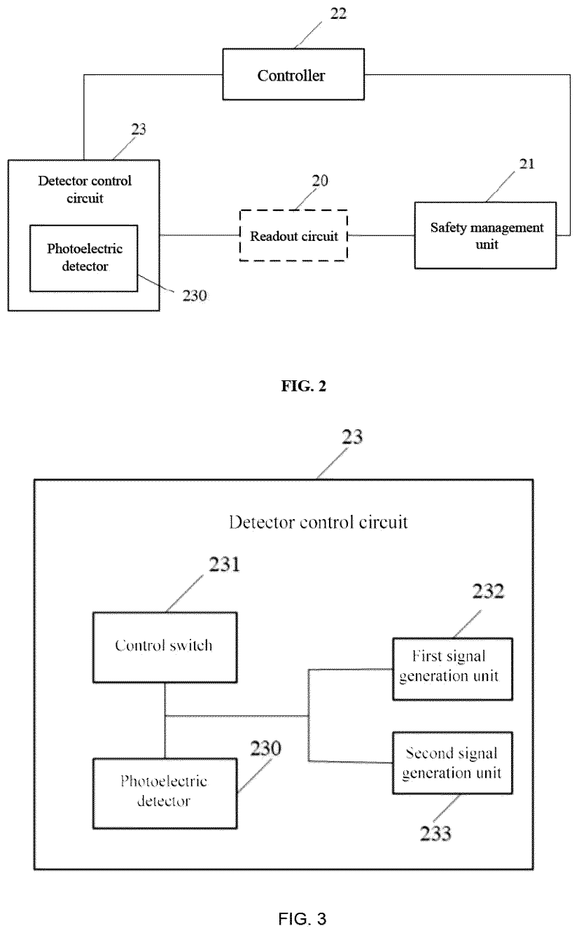

FIG. 3 shows a schematic diagram illustrating an example structure of a detector control circuit in the apparatus for monitoring the readout circuit of the LiDAR, consistent with some embodiments of this disclosure.

In some embodiments, in addition to the photoelectric detector 230, the detector control circuit 23 further includes: a control switch 231, and a first signal generation unit 232 or a second signal generation unit 233. FIG. 3 illustrates an example situation where both the first signal generation unit 232 and the second signal generation unit 233 are provided.

The control switch 231 can switch the photoelectric detector 230 from the activated state to the inactivated state based on the control signal.

The first signal generation unit 232 can output a first diagnostic signal to the readout circuit 20 after the control switch 231 switches the photoelectric detector 230 from the activated state to the inactivated state.

The second signal generation unit 233 can output a second diagnostic signal to the readout circuit 20, after the control switch 231 switches the photoelectric detector 230 from the activated state to the inactivated state.

After receiving the control signal, the control switch 231 can switch the state to reduce the bias voltage across the photoelectric detector 230 to below its breakdown voltage. The photoelectric detector 230 can be switched to the inactivated state and does not respond to light signals. When the control switch 231 switches the state, a voltage change can occur in the circuit, and a pulse signal can be generated. The first signal generation unit 232 can output the first diagnostic signal in response to the voltage change. The second signal generation unit 233 can output the second diagnostic signal in response to the voltage change.

In some embodiments, the detector control circuit 23 can be implemented in various ways. For example, the control switch can include a first switch and a second switch. Two terminals of the first switch can be connected to a power source and the photoelectric detector 230, respectively. Two terminals of the second switch can be connected to the photoelectric detector 20 and the ground, respectively. The control terminals of the first switch and the second switch can be connected to an output terminal of the controller 22, respectively. In some embodiments, the control switch can also be implemented by other types of switch, and other circuit designs of the detector control circuit 23 can also be used, as long as that the photoelectric detector can be switched from the activated state to the inactivated state by switching states of the control switch, which are not limited in this disclosure.

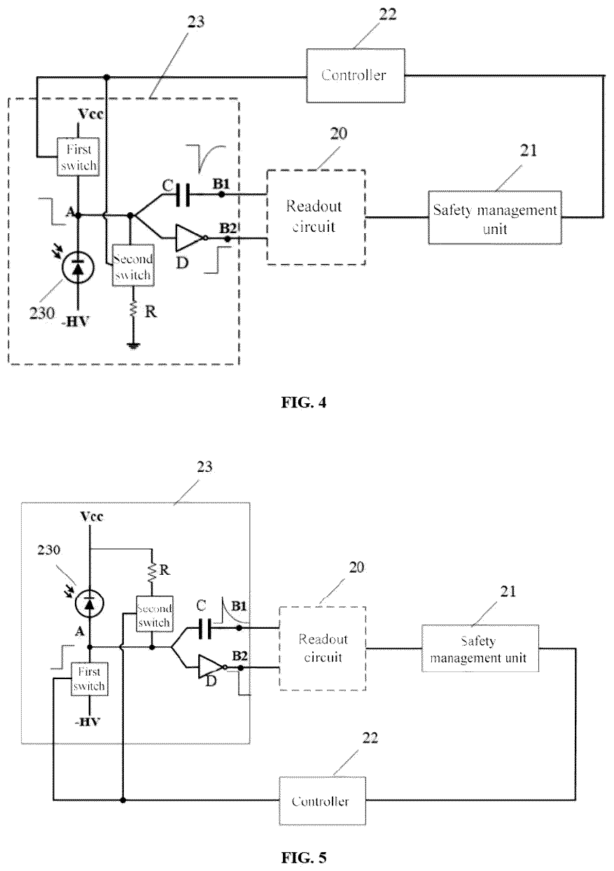

FIG. 4 shows a schematic diagram illustrating an example implementation structure of an apparatus for monitoring the readout circuit of the LiDAR, consistent with some embodiments of this disclosure.

Referring to FIG. 3 and FIG. 4, in some embodiments, the photoelectric detector 230 includes a photodiode, and an anode of the photodiode is connected to a negative high voltage (e.g., “−HV” in the FIG. 4). The control switch 231 includes a first switch and a second switch in FIG. 4. Two terminals of the first switch are respectively connected to the power source (e.g., “Vcc” in FIG. 4) and a cathode of the photodiode (e.g., node “A” in FIG. 4), one terminal of the second switch is connected to the cathode of the photodiode, and the other terminal is grounded through a resistor R. Control terminals of the first switch and the second switch are connected to the output terminal of the controller 22. ON and OFF states of the first switch and the second switch can be controlled by the output of the controller 22.

In some embodiments, the first signal generation unit 232 can include a first generation circuit, and the second signal generation unit 233 can include a second generation circuit. For example, the first signal generation unit 232 includes a capacitor C. A terminal of the capacitor C is connected to the cathode of the photodiode. The other terminal is used as a first output terminal of the detector control circuit 23 (e.g., node “B1” in FIG. 4). The second signal generating unit 233 includes an inverter D, an input terminal of the inverter D is connected with the cathode of the photodiode, and an output terminal is used as a second output terminal of the detector control circuit 23 (e.g., node “B2” in FIG. 4). In some embodiments, the first signal generation unit 232 and the second signal generation unit 233 can also be implemented by other devices to achieve the acquisition or conversion of circuit signals, and the detector control circuit can include one or more signal generation units (e.g., 1, 2, 3, 10, or the like), which is not limited in this disclosure.

In some embodiments, referring to FIG. 4, the controller 22 can send a control signal to the first switch and the second switch to turn on or off the first switch and the second switch, so that the photoelectric detector 230 can enter into the activated state or the inactivated state.

When the photoelectric detector 230 operates normally. For example, when the photoelectric detector 230 is used to detect echo signals, the controller 22 can control the first switch to be turned on and the second switch to be turned off. Node A is at a high voltage (e.g., “Vcc” in FIG. 4). Because the anode of the photodiode is connected to the negative high voltage, the bias voltage across the photodiode 230 can exceed its breakdown voltage, the photodiode 230 can enter into the activated state, the photodiode 230 can respond to the light signal and perform photoelectric detection.

When diagnosing the readout circuit, the safety management unit 21 can send a readout circuit diagnostic command to the controller 22. When receiving the readout circuit diagnostic command output by the safety management unit 21, the controller 22 can output a control signal to the detector control circuit 23. In some embodiments, the control signal can be used to turn off the first switch and simultaneously turn on the second switch. When the first switch is turned off and the second switch is turned on, the voltage at node A drops from the high voltage Vcc to 0. The bias voltage across the photodiode 230 decreases to be lower than its breakdown voltage. The photodiode 230 can enter into the inactivated state, and does not respond to the light signal. The voltage jump signal at node A can generate AC coupling when passing through the capacitor C, resulting in a negative peak pulse at node B1. The amplitude and width of the peak pulse are relevant to the capacitor's parameters. The voltage at node B2 can jump from a low level to a high level.

Correspondingly, the pulse signal generated at node BI is outputted to the readout circuit 20, and the readout circuit 20 can output corresponding diagnostic data to the safety management unit 21. The safety management unit 21 can determine whether the fault exists in the readout circuit 20 based on the diagnostic data. The safety management unit 21 can determine whether the fault exists in the readout circuit 20 by comparing the diagnostic data with reference data. The reference data can be the readout data output by the readout circuit 20 based on the diagnostic data when the readout circuit 20 functions normally.

The readout circuit 20 can also read output information (e.g., a jumping state, a jumping time, or the like) of the inverter D and output corresponding diagnostic data. The safety management unit 21 can determine whether the fault exists in the readout circuit 20 based on the diagnostic data.

For example, the reference data can be obtained through testing after the LiDAR has been operating for a period of time. By doing so, the reference data can be used to possible changes after the capacitor has been operating for a long time.

FIG. 5 shows a schematic diagram illustrating another example implementation structure of an apparatus for monitoring the readout circuit of the LiDAR and the detector control circuit, consistent with some embodiments of this disclosure.

Referring to FIGS. 3, 4, and 5, in some embodiments, the photoelectric detector 230 further includes a photodiode, and the cathode of the photodiode is connected to the power source (e.g., “Vcc” in FIG. 5). FIG. 5 differs from FIG. 4 in connection of the photoelectric detector 230, the first switch and the second switch. Two terminals of the first switch are connected to the negative high voltage (e.g., “−HV” in FIG. 5) and the anode of the photodiode (e.g., node “A” in FIG. 5), respectively. A terminal of the second switch is connected to the anode of the photodiode. The other terminal is connected with the power source (e.g., “Vcc” in FIG. 5) through a resistance R. Control terminals of the first switch and the second switch are connected to the output terminal of the controller 22. ON and OFF states of the first switch and the second switch are controlled by the output of the controller 22.

In some embodiments, the first signal generation unit 232 and the second signal generation unit 233 can be the examples described in association with FIG. 4, such as a capacitor C and an inverter D, respectively.

In some embodiments, referring to FIG. 5, the controller 22 can send a control signal to the first switch and the second switch to turn on or off the first switch and the second switch. By doing so, the photoelectric detector 230 can enter into the activated state or the inactivated state.

When the photoelectric detector 230 operates normally, the first switch is turned on, the second switch is turned off, node A is at a negative high voltage (e.g., “−HV” in FIG. 5), the bias voltage across the photoelectric detector 230 reaches its breakdown voltage, and the photodiode 230 enters into the activated state in response to the light signal and performs photoelectric detection.

When diagnosing the readout circuit, the safety management unit 21 can send the command for readout circuit diagnosis to the controller 22. When receiving the readout circuit diagnostic command output by the safety management unit 21, the controller 22 can output a control signal to the detector control circuit 23. In some embodiments, the control signal can be used to turn off the first switch and simultaneously turn on the second switch. When the first switch is turned off and the second switch is turned on, the voltage at node A can increase from 0 to Vcc, and the bias voltage across the photoelectric detector 230 can decrease to be lower than its breakdown voltage. The photodiode can enter into an inactivated state, and does not respond to the light signal. The voltage jump signal at node A can generate AC coupling when passing through the capacitor C, resulting in a positive peak pulse at node B1. The amplitude and width of the peak pulse are relevant to the capacitor's parameters. The voltage at node B2 can jump from a high level to a low level.

Accordingly, the pulse signal generated by node B1 is outputted to the readout circuit 20 as a diagnostic signal, and the readout circuit 20 can output the corresponding diagnostic data. The safety management unit 21 can determine whether the fault exists in the readout circuit 20 based on the diagnostic data. For example, if a deviation between the diagnostic data and the reference data is beyond a predetermined range, it is determined that the fault exists in the readout circuit 20. In some embodiments, if the deviation between the diagnostic data and the reference data is within the predetermined range, it is determined that the fault does not exist in the readout circuit 20.

Correspondingly, the readout circuit 20 can also read output information of inverter D, such as jumping state, jumping time, or the like, and the readout circuit 20 can output corresponding diagnostic data. The safety management unit 21 can also determine whether the fault exists in the readout circuit 20 based on the diagnostic data.

Based on the apparatus for monitoring the readout circuit of the LiDAR provided in some embodiments of this disclosure, after initiating the diagnosis of the readout circuit, the diagnostic signal can be output to the readout circuit by responding to the diagnostic command through a circuit. Because the diagnosis signal input to the readout circuit is not affected by other factors and at this time the photoelectric detector is in an inactivated state without sensing light signals input from exterior. The diagnostic signal input to the readout circuit can remain consistent and determinate without being affected by ambient light. The readout circuit can output determinate data (e.g., diagnostic data) based on the diagnostic signal, whether the fault exists in the readout circuit can be determined more accurately based on the diagnostic data output by the readout circuit. Monitoring of the readout circuit in a simple, convenient, and accurate way can be allowed.

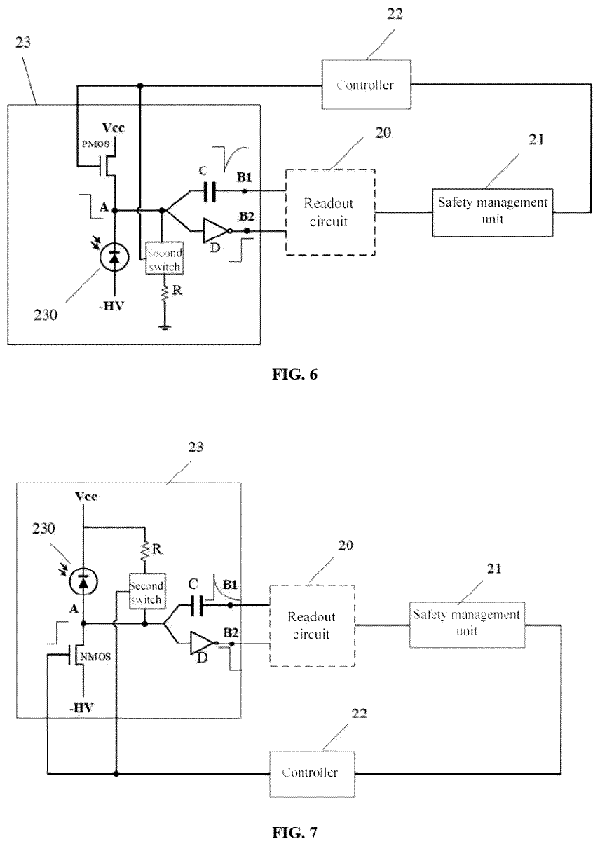

FIG. 6 illustrates an example of a first switch in the apparatus for monitoring the readout circuit of the LiDAR shown in FIG. 4.

In some embodiments, the first switch mentioned above can be implemented by using a PMOS transistor or a NMOS transistor. For example, the first switch in FIG. 4 can be a PMOS transistor, as shown in FIG. 6.

Referring to FIG. 6, a source of the PMOS transistor is connected to the power source (e.g., “Vcc” in FIG. 6), a drain of the PMOS transistor is connected to the cathode of the photodiode, and a gate of the PMOS transistor is connected to the output terminal of the controller 22. The anode of the photodiode is connected to a negative high voltage (e.g., “−HV” in FIG. 6).

In some embodiments, when the photodiode is required to operate, the controller 22 can output a low-level signal, the second switch can be turned off and the PMOS transistor can become conductive by the low-level signal, and the voltage of node A can become a reference high voltage, such as Vcc. The bias voltage of the photodiode can reach a cut-in voltage, the photodiode enters into the activated state, and can receive light signal. The detection channel corresponding to the photodiode can be in a state of detecting the echo light signal.

When receiving a readout circuit diagnostic command output by the safety management unit 21, the controller 22 can output the control signal to the detector control circuit 23. The control signal can be at high level, the second switch can be turned on and the PMOS transistor can be turned off by the high-level signal. By doing so, the bias voltage of the photodiode cannot reach its cut-in voltage, and the photodiode enters into the inactivated state. At this time, the voltage of node A can jump from Vcc to 0, and the voltage jump signal can cause the readout circuit 20 to output the corresponding diagnostic data. Correspondingly, the safety management unit 21 can determine whether the fault exists in the readout circuit 20 based on the diagnostic data.

FIG. 7 illustrates an example of a first switch in the apparatus for monitoring the readout circuit of the LiDAR shown in FIG. 5. Referring to FIG. 7, in some embodiments, the first switch in FIG. 5 can be implemented by an NMOS transistor, and the output terminal of the controller 22 is connected to a gate of the NMOS transistor. A source of the NMOS transistor is connected to the anode of the photodiode, and a drain of the NMOS transistor is connected to a negative high voltage (e.g., “−HV” in FIG. 7).

In some embodiments, when the controller 22 outputs a high level, the second switch can be turned off, the NMOS transistor can become conductive, the voltage of node A can be a negative high voltage (e.g., “−HV” in FIG. 7), and the photodiode can enter into the activated state. The photodiode can receive light signals at this time, and the detection channel corresponding to the photodiode can be in a state of detecting echo light signals.

After receiving a readout circuit diagnostic command output by the safety management unit 21, the controller 22 can output the control signal to the detector control circuit 23. The control signal can be at low level, so that the second switch can be turned on and the NMOS transistor can be cut off accordingly, the bias voltage of the photodiode is difficult to reach its cut-in voltage, and the photodiode can enter into the inactivated state. At this time, the voltage of node A can jump from negative high voltage −HV to 0, and the voltage jump signal can cause the readout circuit 20 to output the corresponding diagnostic data. Correspondingly, the safety management unit 21 can determine whether the fault exists in the readout circuit 20 based on this diagnostic data.

In some embodiments, the power source Vcc mentioned above can be the reference high voltage of the photoelectric detector 230, for example, it can be 3.3V. In some embodiments, the value of Vcc can be determined based on actual needs, which is not limited in this disclosure.

As mentioned earlier, the readout circuit 20 can output, based on the first diagnostic signal output by the detector control circuit 23 (e.g., the pulse signal output by the capacitor C) and/or the second diagnostic signal (e.g., the level jump signal output by the inverter D), corresponding diagnostic data.

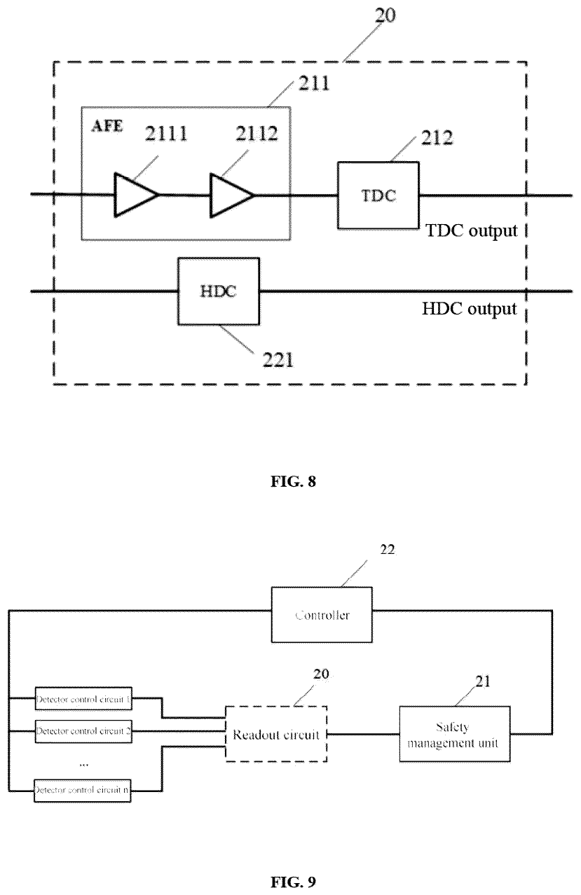

FIG. 8 shows a schematic diagram illustrating an example structure of the readout circuit, consistent with some embodiments of this disclosure.

Referring to FIG. 8, in some embodiments, the readout circuit 20 includes two branches, the time-to-digital converter (“TDC”) branch and the histogram digital converter (or the histogram direct convey module, or “HDC”) branch.

In some embodiments, HDC can be used to convert some digital signals to histogram. HDC can include multiplexer, remapping circuit, or the like.

In some embodiments, the readout circuit 20 can include the TDC branch, or the HDC branch, or both branches. The readout circuit 20 can further include other branches for data reading, which is not limited in this disclosure.

Referring to FIG. 8, the TDC branch includes analog front end (“AFE”) 211 and TDC 212. AFE 211 includes an amplifier 2111 and a comparator 2112. In some embodiments, AFE 211 can include no amplifier 2111. The amplifier 2111 amplifies the signal, while the comparator 2112 converts the peak pulse into a square wave pulse by comparing the input voltage with a reference voltage.

Referring to FIGS. 6, 7, and 8, the first diagnostic signal output by the detector control circuit 23 (e.g., pulse signal output by capacitor C mentioned above) can be input into the TDC branch of the readout circuit 20. AFE 211 can convert this pulse signal into a square wave signal. TDC 212 can obtain information of the square wave pulse, such as a rising edge, falling edge, pulse width, or the like. For a known waveform, when the readout circuit 20 operates normally, readout data from TDC 212 should be set within a predetermined range. For example, a time interval, between a time when the rising edge is generated and a time when the safety management unit 21 can send the diagnostic command, should fall within a predetermined delay time range, and the pulse width should fall within a set range. The safety management unit 21 can determine whether the fault exists in the TDC branch of the readout circuit 20, based on the readout data from TDC 212.

The second diagnostic signal output by the detector control circuit 23 (e.g., a level jump signal output by the inverter D) can be input into the HDC branch of the readout circuit 20. HDC 221 can read the output data of the inverter D, such as the jumping content, a jumping time, or the like.

Referring to FIG. 6, in some embodiments, after a voltage jumping process at node A is input into the inverter D, the output of the inverter D can jump from 0 to 1. When the safety management unit 21 diagnoses that the output of HDC 221 jumps from 0 to 1, it can be determined that the controller 22, the detector control circuit 23 and the HDC branch of the readout circuit 20 are in connection. The safety management unit 21 can also determine whether a time interval between a time when receiving the signal jumping and a time when transmitting the diagnostic signal falls within the predetermined delay time range. When it falls within the predetermined range, it can be determined that the readout function of the HDC branch of the readout circuit 20 is normal.

The readout ways of HDC 221 in FIG. 7 are similar to that in FIG. 6 and do not be repeated here.

FIG. 9 shows a schematic diagram illustrating an example apparatus for monitoring the readout circuit of the LiDAR having a plurality of detector control circuits provided, consistent with some embodiments of this disclosure. In some embodiments, a plurality of detector control circuits can be connected to the same readout circuit. Referring to FIG. 9, in detector control circuits are included, all of which are connected to the readout circuit 20, for example, one readout circuit 20 processes the detection signals from n photoelectric detectors. The readout circuit 20 superimposes the signals output by the n photoelectric detectors.

In some embodiments, the diagnostic command sent by the safety management unit 21 can carry a detector channel identifier, for example, information indicating channels in which the photoelectric detectors can be to be diagnosed. In some embodiments, the controller 22 can send control signals to the detector control circuits in these channels simultaneously, so that the photoelectric detectors in these channels switch from the activated state to the inactivated state, a plurality of corresponding detector control circuits can output diagnostic pulse signals. The readout circuit 20 can superimpose a plurality of diagnostic pulse signals and output the superimposed pulse signal, such as diagnostic data.

In some embodiments, the diagnostic data output by the readout circuit 20 varies based on the number of detector control circuits selected for diagnosis. Correspondingly, the corresponding reference data used to determine whether the diagnostic data is normal can also be different. In some embodiments, the corresponding reference data can be stored in the safety management unit 21. The safety management unit 21 can obtain the corresponding reference data based on the number of detector control circuits selected for diagnosis and compare the diagnostic data with the reference data to determine whether the readout circuit functions normally.

Furthermore, it should be noted that one or more readout circuits can be provided in the receiving system of the LiDAR, each of the readout circuits connected to one or more detector control circuits. Each of the readout circuits can perform fault diagnosis based on the methods described in the various embodiments.

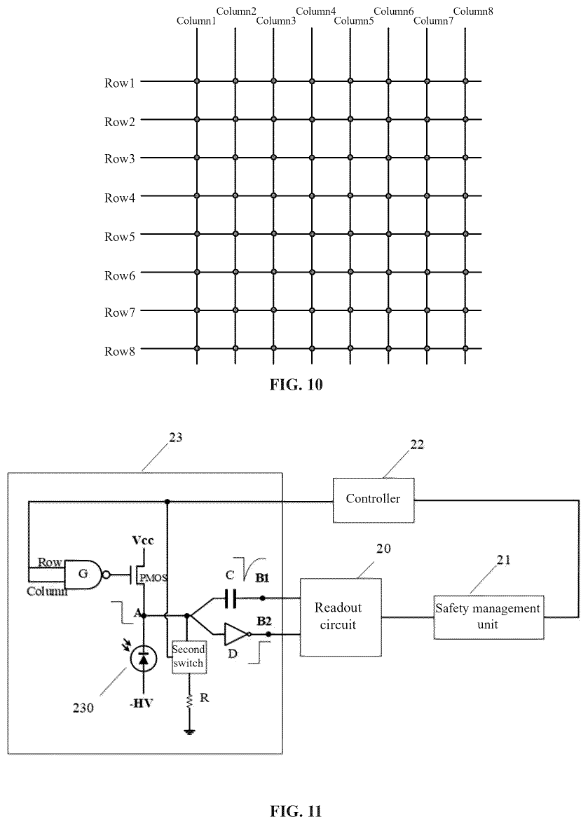

FIG. 10 shows a schematic diagram illustrating an example two-dimension structure of a two-dimension detector control circuit corresponding to a two-dimension photoelectric sensor array, consistent with some embodiments of this disclosure. In some embodiments, the photoelectric detector can be arranged in a one-dimension or two-dimension array. Correspondingly, the plurality of detector control circuits can be arranged in a one-dimension or two-dimension array as well. An example structure of the two-dimension array is shown in FIG. 10, and includes a plurality of rows and columns.

One readout circuit can be simultaneously connected to a plurality of detector control circuits, for example, one readout circuit receives output signals from the plurality of detector control circuits. Each of the detector control circuits can include one or more photoelectric detectors. When detecting the readout circuit, the control signals can be simultaneously output to the plurality of photoelectric detectors corresponding to the readout circuit, thus a plurality of diagnostic pulse signals are input to the readout circuit. The readout circuit can superimpose the plurality of diagnostic pulse signals to obtain a stronger diagnostic pulse signal. Because the diagnostic pulse signals output by respective detector control circuits can be the same, when the number of photoelectric detectors simultaneously connected to the readout circuit is known, the corresponding reference data can be determined. By comparing the diagnostic data output by the readout circuit with the corresponding reference data, whether the readout circuit is in a normal state or in a faulty state can be determined. By diagnosing the readout circuit with a plurality of detector control circuits, the influence of the case that the diagnostic signal of a single detector control circuit is too weak can be decreased, the possibility of the readout circuit fails to make response normally can be decreased, or the readout circuit fails to make response normally can be avoided.

FIG. 11 shows a schematic diagram illustrating an example control principle of a two-dimension detector control circuit, consistent with some embodiments of this disclosure. In some embodiments, the two-dimension array of the photoelectric detectors can include a single photon avalanche diode (SPAD) array. Referring to FIG. 11, there are two inputs for the switching signals of each SPAD, namely the row signal and the column signal. Each detector control circuit 23 can be provided with a NAND gate G. When both the row signal (e.g., “Row” in FIG. 11) and the column signal (e.g., “Column” in FIG. 11) are high-level signals at the same time, the NAND gate G can output a low-level signal, thus the PMOS transistor is conductive, and the voltage at node A becomes high voltage (e.g., “Vcc” in FIG. 11). The bias voltage (e.g., Vcc plus HV) across the photodiode can exceed the breakdown voltage, the SPAD in that channel can enter into the activated state and can be able to detect the echo light signal.

When detecting the readout circuit 20, the safety management unit 21 can output a diagnostic command to the controller 22, and the row signal and/or column signal output by the controller 22 is a low-level signal. Thus, the NAND gate G can output a high-level signal, the PMOS transistor can be cut off, and the voltage at node A can jump from Vcc to 0. At this time, the photoelectric detector does not detect the echo signal. The readout circuit 20 can output diagnostic data based on this voltage jump signal. Correspondingly, the safety management unit 21 can determine whether the fault exists in the readout circuit 20 based on the diagnostic data.

It can be seen that no matter a one-dimension or a two-dimension array of the photoelectric detectors is used in the LiDAR, the apparatus for monitoring the readout circuit of the LiDAR provided in the embodiments of this disclosure can monitor the readout circuit of the LiDAR under the control by the safety management unit 21, the accuracy of the readout data when the LiDAR operates can be improved or ensured.

In some embodiments, the safety management unit 21 can make a fault response after determining that the fault exists in the readout circuit 20.

In some embodiments, the fault response of the safety management unit 21 can be implemented through software, hardware, or a combination of software and hardware.

In some embodiments, the safety management unit 21 can determine the fault level of the readout circuit and make a fault response based on the fault level. For example, the fault can be divided into two levels. After determining the fault level of the readout circuit 20 as a first level, the safety management unit 21 can send a fault code to a main controller. In some embodiments, after determining the fault level of the readout circuit 20 as a second level, the safety management unit 21 can send a fault code to the main controller and stops transmitting point cloud data to the main controller. The fault code can include but not limited to: readout circuit fault indication information, identification information indicating a faulty readout circuit, or the like.

In some embodiments, when the safety management unit 21 detects that a deviation between diagnostic data and reference data is beyond a predetermined range, a fault response can be made. A plurality of predetermined ranges can be set. Correspondingly, a fault level of the readout circuit can be determined based on correspondence between the deviation and the plurality of predetermined ranges, and different fault responses can be made based on the fault level. For example, a smaller range and a larger range can be set based on the predetermined range. For example, the first predetermined range for a time interval between a time of the rising edge of the diagnostic pulse signal and time for sending the diagnostic command is 2 ms±5 μs, and the second predetermined range is 2 ms±10 μs. When the deviation exceeds ±5 μs but does not exceed ±10 μs, it can indicate that the fault exists in the readout circuit 20, but the fault level is low, and a first level fault response can be made. In some embodiments, when the deviation exceeds ±10 μs, it indicates that the fault level of the readout circuit 20 is relatively high, and a second level fault response can be made.

In some embodiments, the fault code can carry information about the readout circuit fault and information indicating a specific faulty readout circuit. The safety management unit 21 can send the fault code to the main controller through the mobile industry processor interface (“MIPI”) interface. The fault code can carry some fault information, such as information indicating which readout circuit is faulty.

In some embodiments, the main controller can provide feedback to the safety management unit 21 through a communication protocol to indicate that the fault alarm information is successfully received. In addition, if the safety management unit 21 does not receive feedback information from the main controller for a long time, the fault alarm information can be sent to the main controller again.

For another example, after determining that there are a fault in the readout circuit 20, the safety management unit 21 can send a fault code to the main controller through an interrupt pin. For example, in the case that one interrupt pin is provided, the interrupt pin can be set as 0 (e.g., outputting low level) to indicate normality, and the interrupt pin is set as 1 to indicate abnormality. The main controller can determine whether the fault exists in the readout circuit based on output of the interrupt pin. Because an interrupt signal has a higher priority, when the interrupt pin outputs information indicating abnormality, the main controller can read a register in the safety management unit 21 immediately and determine fault information of the readout circuit based on the read data, such as the fault level, information indicating which readout circuit has a fault, or other like.

Furthermore, a plurality of interrupt pins can be used, and information output by the plurality of interrupt pins can be used to indicate the fault level. For example, two interrupt pins can be provided, and the information 00 output by the interrupt pins can represent normality, 01 can represent mild abnormality, 10 can represent a relatively severe abnormality, and 11 can represent a very severe abnormality. The main controller can set the corresponding response time based on the severity of the abnormality indicated by the interrupt pins.

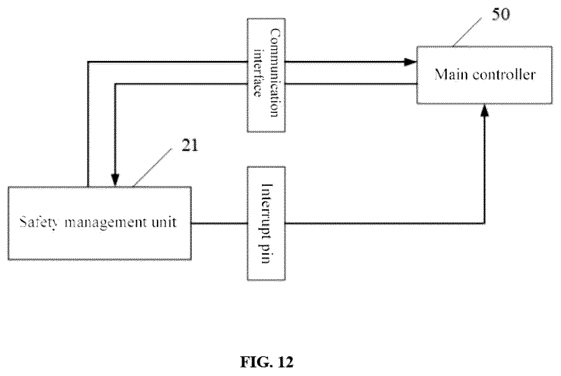

FIG. 12 shows a schematic diagram illustrating an example principal of a fault response made by a safety management unit in an apparatus for monitoring the readout circuit of the LiDAR, consistent with some embodiments of this disclosure. Referring to FIG. 12, in some embodiments, after determining that the fault exists in the readout circuit 20, the safety management unit 21 can send a fault signal to the main controller 50 through an interrupt pin. The fault signal can be used to indicate the fault of the readout circuit and/or the fault level.

Correspondingly, after receiving the fault signal, the main controller 50 can read the data stored in the safety management unit 21 through a low-speed communication interface and determine fault information of the readout circuit 20 based on the read data. By using this method, the bandwidth of a MIPI interface does not be occupied.

It should be understood that each module/unit in the embodiments described in this disclosure can include one or more physical components in whole or in part. For example, a module/unit can be implemented as a processor, a controller, a computer or any form of hardware components. As another example, a module/unit can include one or more hardware components and one or more software components. For example, the module can include a processor (e.g., a digital signal processor, microcontroller, field programmable gate array, a central processor, an application-specific integrated circuit or the like) and a computer program, when the computer program is run on the processor, the function of the module can be realized, the computer program can be stored in a memory (e.g., a random access memory, a flash memory, a read-only memory, an programmable read-only memory, a register, a hard disk, a removable hard disk, or a storage medium of any other form) or server.

In some embodiments, the safety management unit 21 can include a processor, a controller or other hardware components for safety management. The safety management can be integrated in a circuit of LiDAR, a field programmable gate array, the main controller 50 or the like.

In conclusion, the apparatus for monitoring the readout circuit of the LiDAR provided in the embodiments of this disclosure can make fault response in various ways after detecting that the fault exists in the readout circuit, thereby fault can be cleared promptly and the impact on the normal operation of the LiDAR is avoided, the accuracy of the readout data of the LiDAR can be ensured or improved.

The method and apparatus for monitoring the readout circuit of the LiDAR provided in the embodiments of this disclosure can monitor the readout circuit without being affected by external ambient light, and there are no need to send an external light signal to the photoelectric detector, thus the detection method is simple and easy to be implemented. At the same time, the detection can be performed during an interval when the photoelectric detector is not operating, the normal operation of the readout circuit does not be affected or the influence can be decreased.

This disclosure provides a LiDAR, including a transmitting end and a receiving end. The transmitting end can transmit detection signals to the target object. The receiving end can receive an echo signal generated after the detection signal is reflected by the target object. The receiving end can include an apparatus for monitoring the readout circuit of the LiDAR based on any of the above embodiments.

The methods provided in this disclosure can be implemented by various embodiments described in association with the accompanying drawings, such as the apparatus provided in this disclosure. For example, the method 100 can be implemented by the apparatus for monitoring the readout circuit of the LiDAR, consistent with embodiments described in association with FIGS. 2-12. It should be noted that each step of the methods described in this disclosure (e.g., method 100) can be performed by the same or different components (e.g., one or more component of the apparatus for monitoring the readout circuit), which is not limited by the examples described in this disclosure.

It should be understood that the term “and/or” in this disclosure is merely a description describing the relationship between associated objects, which indicates three relationships, for example, “A and/or B” indicates: only “A”, only “B”, and both “A” and “B”. In addition, the sign “/” in this disclosure indicates an “or” relationship between the preceding and following associated objects.

The term “a plurality of” in this embodiment refers to two or more.

The “first”, “second” and other descriptions in this disclosure are used for illustration and distinction of the described objects, which do not indicate sequence, or indicate any special restrictions on the number of devices in this disclosure. They do not constitute any limitations on this disclosure.

The term “connection” in this disclosure refers to various connection methods such as direct connection or indirect connection to implement communication between devices. This embodiment does not make any limitations on this.

Although this disclosure has been disclosed as above, this disclosure is not limited thereto. Those skilled in the art can make various modifications and changes within the spirit and scope of this disclosure, and therefore, the scope of protection of the present disclosure should be defined by the claims.

1. A method for monitoring a readout circuit of a LiDAR, comprising:
initiating a diagnosis of the readout circuit;
outputting a diagnosis signal to the readout circuit, and outputting, determining diagnosis data, wherein the diagnosis data is output by the readout circuit based on the diagnosis signal, the diagnosis signal is generated by switching a photoelectric detector from an activated state to an inactivated state; and
determining whether a fault exists in the readout circuit by comparing the diagnosis data with reference data, wherein the reference data is readout data outputted based on the diagnosis signal when the readout circuit functions normally.

2. The method of claim 1, wherein the LiDAR comprises a plurality of readout circuits, and initiating the diagnosis of the readout circuit comprises:
initiating diagnoses of the plurality of readout circuits in parallel.

3. (canceled)

4. (canceled)

5. The method of claim 2, wherein determining whether the fault exists in the readout circuit by comparing the diagnosis data with the reference data comprises:
based on a determination that a deviation between the diagnosis data and the reference data is beyond a predetermined range, determining that the fault exists in the readout circuit; or
based on a determination that the deviation between the diagnosis data and the reference data is within the predetermined range, determining that the fault does not exist in the readout circuit.

6. The method of claim 5, further comprising: making a fault response after determining that the fault exists in the readout circuit.

7. The method of claim 6, wherein the method further comprises:
determining a fault level of the readout circuit based on the deviation and the predetermined range, and making the fault response based on the fault level.

8. An apparatus for monitoring a readout circuit of a LiDAR, the apparatus comprising:
a safety management circuit, a controller, and a detector control circuit,
wherein:
the detector control circuit comprises a photoelectric detector;
the safety management circuit is configured to send a command for readout circuit diagnosis to the controller;
the controller is configured to output a control signal to the detector control circuit after receiving the command, wherein the control signal is for switching the photoelectric detector from an activated state to an inactivated state;
the detector control circuit is configured to switch the photoelectric detector from the activated state to the inactivated state based on the control signal, and output a diagnosis signal to the readout circuit;
the readout circuit is configured to output diagnosis data to the safety management circuit based on the diagnosis signal; and
the safety management circuit is further configured to receive the diagnosis data, and determine whether a fault exists in the readout circuit by comparing the diagnosis data with reference data, wherein the reference data is readout data output based on the diagnosis signal when the readout circuit functions normally.

9. (canceled)

10. (canceled)

11. The apparatus of claim 8, wherein;
the detector control circuit comprises a control switch, a first signal generation circuit, and a second signal generation circuit;
the control switch is configured to switch the photoelectric detector from the activated state to the inactivated state based on the control signal;
the first signal generation circuit is configured to output a first diagnosis signal to the readout circuit after the control switch switches the photoelectric detector from the activated state to the inactivated state; and
the second signal generation circuit is configured to output a second diagnosis signal to the readout circuit after the control switch switches the photoelectric detector from the activated state to the inactivated state.

12. The apparatus of claim 11, wherein the control switch comprises a first switch and a second switch.

13. The apparatus of claim 12, wherein:
a first end of the first switch is configured to be connected to a power source, a second end of the first switch is configured to be connected to the photoelectric detector, a first end of the second switch is configured to be connected to the photoelectric detector, a second end of the second switch is configured to be connected to ground; and
after the controller outputs the control signal, the first switch is turned off and the second switch is turned on.

14. The apparatus of claim 13, wherein the first switch comprises a PMOS transistor or an NMOS transistor.

15. The apparatus of claim 11, wherein the first signal generation circuit comprises a capacitor, a first terminal of the capacitor is configured to be connected to the photoelectric detector, and a second terminal of the capacitor is configured to be a first output terminal of the detector control circuit.

16. The apparatus of claim 11, wherein the second signal generation circuit comprises an inverter, an input terminal of the inverter is configured to be connected to the photoelectric detector, and an output terminal of the inverter is configured to be a second output terminal of the detector control circuit.

17. (canceled)

18. (canceled)

19. The apparatus of claim 8, wherein the safety management circuit is further configured to make a fault response based on a determination that the fault exists in the readout circuit.

20. The apparatus of claim 19, wherein the safety management circuit is further configured to determine a fault level of the readout circuit and make a fault response based on the fault level.

21. The apparatus of claim 8, wherein the safety management circuit is further configured to send a fault code to a main controller via a communication interface.

22. The apparatus of claim 21, wherein the safety management circuit is configured to:
send the fault code to the main controller after determining the fault level of the readout circuit as a first level; and
send the fault code to the main controller and stop sending point cloud data to the main controller after determining the fault level of the readout circuit as a second level.

23. The apparatus of claim 22, wherein the fault code comprises readout circuit fault indication information and identification information indicating a faulty readout circuit.

24. The apparatus of claim 20, wherein:
the safety management circuit is configured to send a fault signal to the main controller via an interrupt pin after determining that the fault exists in the readout circuit; and
the main controller is configured to read data stored in the safety management circuit via a communication interface after receiving the fault signal, and determine fault information of the readout circuit based on the read data.

25. The apparatus of claim 24, wherein the fault signal sent to the main controller via the interrupt pin is used to indicate a fault in the readout circuit and/or the fault level.

26. A LiDAR, comprising a transmitting end and a receiving end, wherein:
the transmitting end is configured to transmit a detection signal towards an object;
the receiving end is configured to receive an echo signal generated after the detection signal is reflected by the object; and
the receiving end comprises the apparatus of claim 8.
